(19) United States
(12) Patent Application Publication
(10) Pub. No.: US 2021/0266413 A1
(43) Pub. Date: Aug. 26, 2021

(54) INFORMATION PROCESSING SYSTEM, INFORMATION PROCESSING APPARATUS, AND METHOD OF CONTROLLING THE SAME

(71) Applicant: Canon Kabushiki Kaisha, Tokyo (JP)

(72) Inventor: Ryotaro Imine, Ibaraki (JP)

(21) Appl. No.: 17/183,551

(22) Filed: Feb. 24, 2021

(30) Foreign Application Priority Data
Feb. 26, 2020 (JP) 2020-030852

(51) Int. Cl. H04N 1/00; G06N 3/08

(52) U.S. Cl. CPC H04N 1/00068; H04N 1/00042; G06N 3/08; H04N 1/00076; H04N 1/00411; H04N 1/00061

(57) ABSTRACT

An information processing apparatus generates a learned model for estimating an operation error situation, using operation information of the information processing apparatus as training data, estimates an error of an operation by a user by using the generated learned model, and makes a notification to the user of an estimation result.

### BACKGROUND OF THE INVENTION

### Field of the Invention

The present invention relates to an information processing system, an information processing apparatus, and a method of controlling the same.

### Description of the Related Art

Conventionally, in a case where a user does not explicitly make a setting instruction on an image forming apparatus, default settings that are specified for the image forming apparatus are used, and jobs are executed in accordance with those default settings. Also, functions for simplification of job setting processes and displaying guidance such as a recommendation of a frequently-used function and independent customization of initial settings by the user exist. Furthermore, there exist image forming apparatuses that display, on a screen of a console unit, a message that prompts with a warning in a case where prohibited settings and contradictory settings are performed, and provide operations for re-confirming settings. However, there are cases in which in spite of this, due to an operation error by a user or a misrecognition, an instruction to execute a job is made with erroneous settings. Accordingly a stop button is always provided on the console unit for accepting interruption of the job by a user who noticed the error in the settings during execution of the job. In other words, in conventional image forming apparatuses, situations occur in which because it cannot be determined whether or not the user setting was due to a misrecognition, an instruction to execute a job with erroneous settings is accepted.

Meanwhile, for erroneous operations by a user, techniques that estimate situations in which an operation error has been made on an apparatus have been proposed. In Japanese Patent Laid-Open No. 2016-119502, information related to a transmission destination is extracted from information included in data that a user is attempting to transmit, and an estimation of an error in the designation of the transmission destination is made by determining whether the data and the destination are consistent from the number of items of information related to the destination. This is something that estimates an error in the designation of the data transmission destination by applying objective features such as information related to the transmission destination being included within the data to be transmitted.

As in the conventional technique described above, in the case of targeting an operation for which a feature for estimating that there is some kind of erroneous operation is clear beforehand, rule-based estimation logic can be decided, but there are cases where this is unclear or undetermined. For example, there are cases where a user has an inherent habit of making a mistake. As with a user's habit, a rule-based embedded implementation cannot be applied to categorization of erroneous operations for unknown features that cannot be confirmed on the apparatus. Accordingly, there is a problem to be solved in adapting products, as an opposing means for implementation to an embedded rules-based implementation, to a method for implementing estimation logic that takes advantage of AI (Artificial Intelligence) machine learning techniques which have been increasingly put into practical use in recent years.

### SUMMARY OF THE INVENTION

An aspect of the present invention is to eliminate the above-mentioned problem with conventional technology.

The feature of the present invention is to provide a technique by which it is possible to effectively learn an erroneous operation situation, and based on the results of that learning, estimate errors, and prevent the execution of jobs by an erroneous operation by making a notification thereof to the user.

According to a first aspect of the present invention, there is provided an information processing apparatus, comprising: at least one processor and at least one memory configured to function as: a learning unit that generates a learned model for estimating an operation error situation, using operation information of the information processing apparatus as training data; an estimation unit that estimates an error of an operation by a user by using the learned model generated by the learning unit; and a notification unit that makes a notification to the user of an estimation result by the estimation unit.

According to a second aspect of the present invention, there is provided an information processing system that has at least an image forming apparatus, a learning server, and a data server, the data server comprising: at least one first processor and at least one first memory configured to cause the data server to: collect data for learning and provide the data for learning to the learning server, the learning server comprising: at least one second processor and at least one second memory configured to cause the learning server to: generate a learned model based on the data for learning provided from the data server, and the image forming apparatus comprising: at least one third processor and at least one third memory configured to function as: an estimation unit that obtains the learned model from the learning server, and estimates an error of an operation by a user by using the learned model; and a notification unit that makes a notification to the user of an estimation result by the estimation unit.

According to a third aspect of the present invention, there is provided a method of controlling an information processing apparatus, the method comprising: generating a learned model for estimating an operation error situation, using operation information of the information processing apparatus as training data; estimating an error of an operation by a user by using the generated learned model; and making a notification to the user of a result of the estimation.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a view for describing a system according to a first embodiment of the present invention.

FIG. 2 is a block diagram for describing a hardware configuration of an image forming apparatus according to the first embodiment.

FIG. 3 is a block diagram for describing a hardware configuration of a machine learning server according to the first embodiment.

FIG. 4 is a block diagram for describing a software configuration of the image forming apparatus, the machine learning server, and a data server according to the first embodiment.

FIGS. 5A and 5B are schematic diagrams illustrating a structure of input/output using a learning model in a machine learning module of the machine learning server according to the first embodiment.

FIGS. 6A through 6C depict views for describing a double-sided setting for when copying as an example of a situation where an operation error occurs in the image forming apparatus according to the first embodiment.

FIGS. 7A and 7B depict views illustrating examples of training data wherein user operations and setting information related to a double-sided setting are the target of learning.

FIG. 8 is a flowchart for describing processing by the image forming apparatus according to the first embodiment.

FIG. 9 is a flowchart for describing estimation processing of step S804 of FIG. 8.

FIG. 10A is a flowchart for describing operation of the data server according to the first embodiment.

FIG. 10B is a flowchart for describing operation of the machine learning server according to the first embodiment.

FIGS. 11A and 11B depict views illustrating examples of screens displayed on a console unit of the image forming apparatus according to the first embodiment.

FIGS. 12A to 12C depict views for respectively describing screens for notifying a result of estimating erroneous operation in the image forming apparatus according to the first embodiment.

FIG. 13 depicts a view illustrating an example of an AI processing setting customization screen displayed on the console unit of the image forming apparatus according to the first embodiment.

FIG. 14 depicts a view illustrating an example of a screen for displaying a result of learning that is to be displayed on the console unit of the image forming apparatus according to the first embodiment.

FIG. 15 depicts a view for describing a software configuration of an image forming apparatus according to a second embodiment of the present invention.

FIG. 16 is a flowchart for describing an operation of the image forming apparatus according to the second embodiment.

FIG. 17 is a flowchart for describing processing of step S1601 of FIG. 16.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Also, a plurality of features may be arbitrarily combined. Also, in the embodiments, examples of the information processing apparatus according to the present invention are described using an image forming apparatus such a multi-function peripheral as an example.

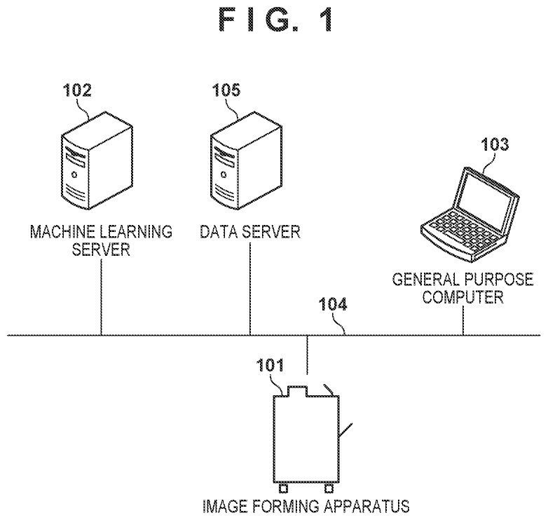

FIG. 1 depicts a view for describing an information processing system according to a first embodiment of the present invention.

This system has an image forming apparatus 101 such as a printer, multi-function peripheral apparatus, or a FAX, a machine learning server 102, a data server 105, and a general purpose computer 103 for performing a transmission of print data to the image forming apparatus 101. Such devices are connected by a network 104 such as a wired LAN. The image forming apparatus 101 has an AI (artificial intelligence) function, and a learned model for realization of this AI function has the role that is centrally generated by the machine learning server 102. The data server 105 has the role of collecting from an external device training data to be used for performing machine learning in the machine learning server 102 and providing it to the machine learning server 102. The image forming apparatus 101 can realize a specific AI function by receiving, as necessary, learned models generated by the machine learning server 102 from the machine learning server 102. Also, the machine learning server 102 can receive, from an external device such as the data server 105, the image forming apparatus 101, or the general purpose computer 103, training data necessary for learned model training for realization of a specific AI function, and can perform training processing using some or all of it.

As a feature of this system, the data server 105 collects erroneous operation situations particular to a user operating the image forming apparatus 101, learns the data on the machine learning server 102, and generates a learning model. The image forming apparatus 101 has an AI function that takes advantage of a learning model that is loaded from the machine learning server 102 and is for estimating erroneous operation situations when the user instructs that a job be executed. With such a system configuration, it is possible to prompt for correction of a setting due to an erroneous operation by making a notification to the user of the erroneous situation.

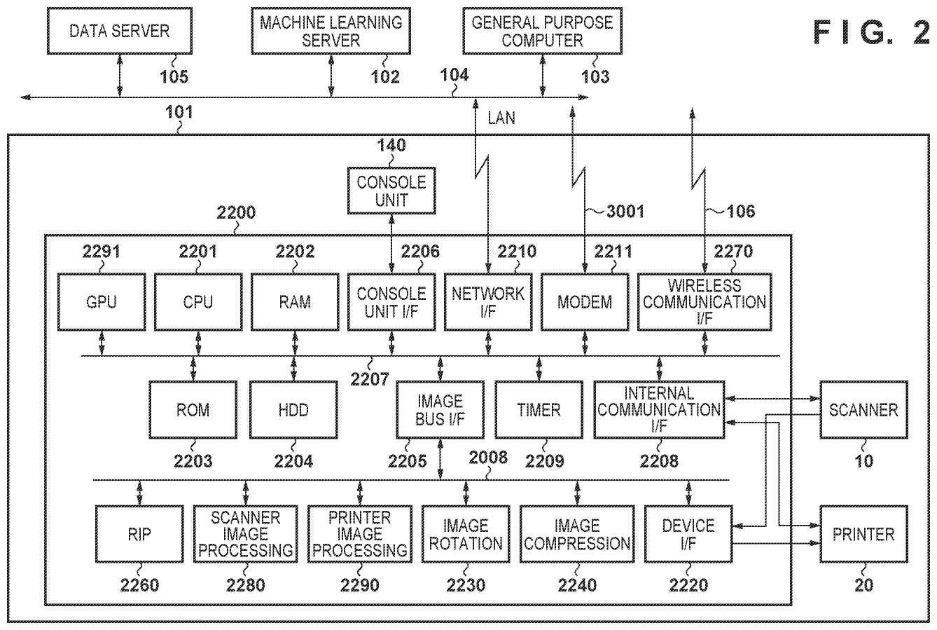

FIG. 2 is a block diagram for explaining a hardware configuration of the image forming apparatus 101 according to the first embodiment.

The image forming apparatus 101 has a console unit 140 for a user to perform various operations, a scanner 10 that reads image information in accordance with an instruction from the console unit 140, and a printer 20 that prints an image onto a sheet based on the image data. The scanner 10 has a CPU (not shown graphically) for controlling the scanner 10, and an illumination lamp, a scanning mirror and the like for performing a read of a document. The printer 20 has a CPU (not shown graphically) for performing control of the printer 20, a photosensitive drum and a fixing unit for performing image formation and fixing, and the like. Also, the image forming apparatus 101 has a controller 2200 for comprehensively controlling operations of the image forming apparatus 101 which is connected to the LAN 104, a public line (WAN) 3001, and the wireless LAN 106.

Next, the internals of the controller 2200 will be described in detail.

The controller 2200 has a raster image processor (RIP) 2260 for rasterizing, into a bitmap image, PDL code included in a print job received from the general purpose computer 103 via the LAN 104. Also, the controller 2200 has a scanner image processor 2280 for correcting, processing, and editing image data input from the scanner 10. Also, the controller 2200 has a printer image processor 2290 for performing correction on image data to be output (printed) by the printer 20, resolution conversion, and the like and an image rotator 2230 for performing a rotation of image data.

Also, the controller 2200 has an image compressor 2240 for performing JPEG compression/decompression processing on multi-value image data and JBIG, MMR, or MH compression/decompression processing on binary image data. Also, the controller 2200 has a device I/F 2220 that connects the scanner 10 and the printer 20 to the controller 2200, and that performs synchronous/asynchronous conversion of image data. Furthermore, the controller 2200 has an image bus 2008 that connects these all to each other and that is for transferring, at high speed, image data.

Also, the controller 2200 has a CPU 2201 as a control unit for comprehensively controlling the image forming apparatus 101. Also, the controller 2200 has a RAM 2202 which is a system work memory for operation of the CPU 2201 and which is an image memory for temporarily storing image data. Also, the controller 2200, via the console unit interface 2206 of the console unit 140, outputs to the console unit 140 image data to be displayed on the console unit 140. Also, the console unit interface 2206 has the role of conveying to the CPU 2201 information that the user of the image forming apparatus 101 has inputt using the console unit 140.

Also, the controller 2200 is connected to the LAN 104, and has a network I/F 2210 for performing communication (transmission/reception) with the general purpose computer 103 and other computer terminals (not shown graphically) on the LAN 104. Also, the controller 2200 has a modem 2211 that is connected to the public line 3001 and is for performing communication (transmission/reception) of data with an external facsimile apparatus (not shown graphically). Also, the controller 2200 has a wireless communication I/F 2270 for connecting an external terminal by the wireless LAN 106. Also, the controller 2200 has a ROM 2203 in which a boot program that the CPU 2201 executes is stored and a hard disk drive (HDD) 2204 for storing system software, image data, software counter values, and the like. Also, the controller 2200 has an internal communication I/F 2208 that performs communication with each of the scanner 10 and the printer 20 and a system bus 2207 that connects these to each other. Furthermore, the controller 2200 has a timer 2209 for keeping time when instructed by the CPU 2201. The controller 2200 has an image bus I/F 2205 that connects the system bus 2207 and the image bus 2008, and functions as a bus bridge for converting data structures. The controller 2200, in the HDD 2204 or the RAM 2202, stores/manages, as job log information, a history of when a job was executed such as a user name, a number of copies, output attribute information, such as that it was a color print, or the like when a printing or copy job is executed.

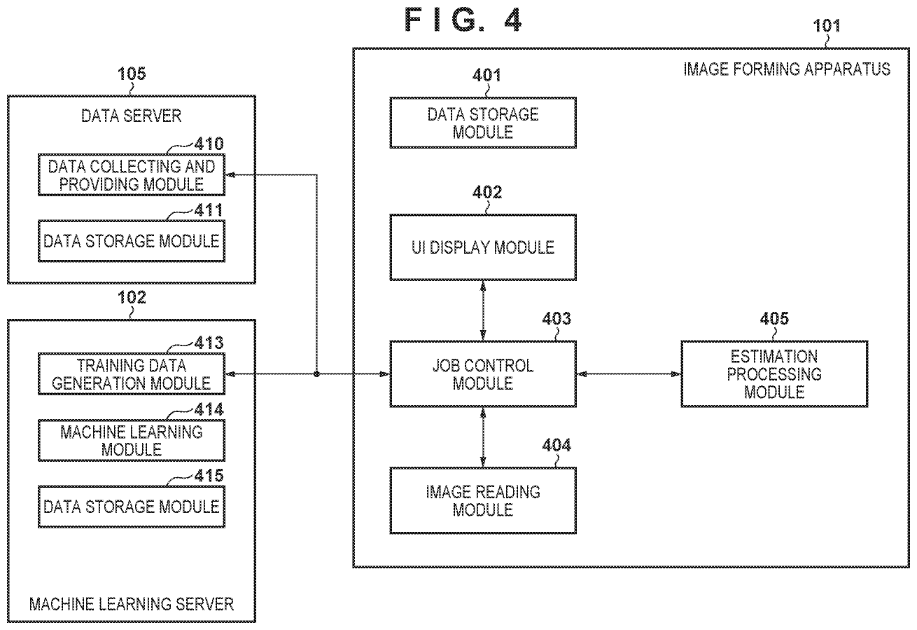

The GPU (graphics processing unit) 2291, since it can perform efficient calculations by more highly parallel processing of data, it is effective to perform processing using the GPU 2291 when performing learning multiple times using a learning model such as in the case of deep learning. Accordingly, in the first embodiment, in a case where a learning program including a learning model is executed, learning is performed by the CPU 2201 doing calculations in cooperation with the GPU 2291. Also, functions of an estimation processing module 405 which will be described later with reference to FIG. 4 may similarly use the GPU 2291.

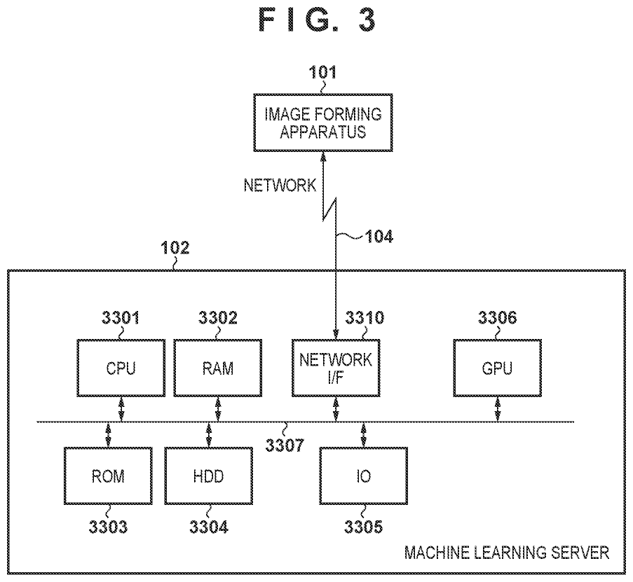

FIG. 3 is a block diagram for explaining a hardware configuration of the machine learning server 102 according to the first embodiment.

The machine learning server 102 has a CPU 3301, a RAM 3302, a ROM 3303, an HDD 3304, a network I/F 3310 and IO (input/output unit) 3305, and a GPU 3306 which are connected to each other respectively by a system bus 3307. The CPU 3301 provides various functions by reading out an OS (Operating System) or programs such as application software from the HDD 3304 and executing them. The RAM 3302 is a system work memory for when the CPU 3301 executes a program. The ROM 3303 stores programs and setting files for activation of a BIOS (Basic Input Output System) and the OS. The HDD 3304 is a hard disk drive, and stores system software and the like. The network I/F 3310 is connected to a wireless LAN, and performs communication (transmission/reception) with an external device such as the image forming apparatus 101. The IO 3305 is an interface for input/output of information with respect to a console unit (not shown graphically) that comprises a display input/output device that comprises a multi-touch sensor or the like. Based on screen information that the program specifies, predetermined information is rendered on the console unit (not shown) at a predetermined resolution and number of colors and the like. For example, various windows and data and the like that form GUI (Graphical User Interface) screens and are necessary for operation are displayed.

Since the GPU 3306 can perform efficient calculations on data by more highly parallel processing, it is effective to perform processing on the GPU 3306 in the case of performing learning multiple times using a learning model as in the case of deep learning. Accordingly, in the first embodiment, the GPU 3306 is used, in addition to the CPU 3301, for processing by the machine learning module 414 of FIG. 4 which will be described later. Specifically, a learning program including a learning model is executed, learning is performed by the CPU 3301 doing calculations in cooperation with the GPU 3306. Note that in processing of the machine learning module 414, calculations may be performed by either the CPU 3301 or the GPU 3306 on its own.

Proper use of the GPU 2291 of the image forming apparatus 101 and the GPU 3306 of the machine learning server 102 is described later.

The calculation resources of the GPU 2291 are to be used effectively in accordance with network communication, a load requiring processing of the GPU 2291, and a power saying mode of the image forming apparatus 101, and the like. For example, in the case where the image forming apparatus 101 transitions to the power saving mode, the GPU 3306 of the machine learning server 102 can be taken advantage of actively.

FIG. 4 is a block diagram for describing a software configuration of the image forming apparatus 101, the machine learning server 102, and the data server 105 according to the first embodiment. A program for realizing a software configuration of the image forming apparatus 101 illustrated in the figure is stored in the HDD 2204 for each of these configuration elements, and functions illustrated in FIG. 4 are achieved by the program being deployed to the RAM 2202, and the program being executed by the CPU 2201. Also, in the machine learning server 102 and the data server 105, the functions are achieved by the program being executed by the CPU of each server after being deployed into the RAM. Also, this software configuration is something for realizing a function in which information of operations made by a user via the console unit 140 or the like of the image forming apparatus 101 are learned, and processing for estimating a situation in which a user performed an erroneous operation is performed.

The software of the image forming apparatus 101 has a data storage module 401, a UI display module 402, a job control module 403, an image reading module 404, and an estimation processing module 405. The software of the machine learning server 102 has a training data generation module 413, a machine learning module 414, and a data storage module 415. Also, the data server 105 has a data collecting and providing module 410 and a data storage module 411.

The data storage module 401 has a functional role of storing, to the RAM 2202 or the HDD 2204, image data and training data and data that the image forming apparatus 101 inputs/outputs for the learning model or the like. The UI display module 402 accepts operations and settings from a user in relation to a display screen of the console unit 140 via the console unit interface 2206 and provides screens for accepting such operations. Furthermore, the UI display module 402 has the role of displaying a notification screen for making a notification of a message to a user of an estimation result or the like by the estimation processing module 405. The job control module 403 has a role of executing basic functions of the image forming apparatus 101 such as copying, faxing, and printing based on user instructions, and centrally transmitting/receiving instructions and data with respect to other software configuration elements involved in execution of basic functions. The image reading module 404, when executing a copy or scan function based on an instruction of the job control module 403, controls to cause a document to be optically read by the scanner 10. The estimation processing module 405 is executed by the CPU 2201 and/or the GPU 2291, and performs estimation processing and classification processing for realizing an AI function in relation to data that the image forming apparatus 101 inputs/outputs. This estimation processing module 405 executes processing based on an instruction of the job control module 403, and the results of estimation by the estimation processing module 405 are transmitted to the job control module 403, and displayed on the console unit 140 as messages by the UI display module 402. In this way, the results of such an estimation are fed back to the user.

Next, functions of the data server 105 will be described. The data collecting and providing module 410 performs collection of training data for training on the machine learning server 102, and provision of the training data to the machine learning server 102. When training data including operation information of the image forming apparatus 101 is received from the image forming apparatus 101 here, it is provided to the machine learning server 102. Also, the collection of the training data may be from an image forming apparatus other than the image forming apparatus 101 or the general purpose computer 103 or another data server. In any case, it becomes possible to collect data needed for the objective machine learning. The data storage module 411 stores and manages the collected training data.

Next, functions of the machine teaming server 102 will be described.

The training data generation module 413, in order to obtain a desired learning effect, processes training data received from the data server 105 into a form in which an effective learning result can be achieved, and by removing unnecessary data such as noise, performs optimization of training data. In the first embodiment, an example of preprocessing of data for effective learning is filtering the information of operations made before/after the stop button of the console unit 140 is pressed from among the information of operations received from the image forming apparatus 101. Configuration is such that it is possible to learn an erroneous operation situation effectively thereby. The machine learning module 414 inputs training data generated by the training data generation module 413, and performs machine learning by taking advantage of a training method by the learning model with the GPU 3306 or the CPU 3301. The data storage module 415 temporarily stores training data received from the data server 105, generated training data, and a learned model obtained by the machine learning module 414 in the RAM 3302 and the HDD 3304.

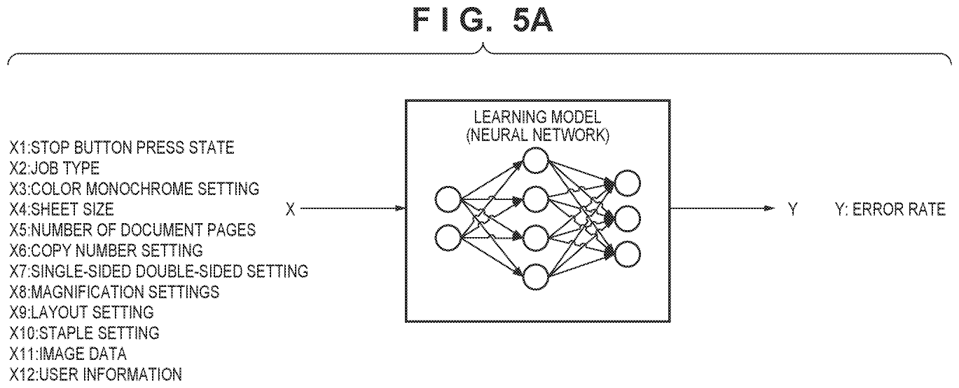

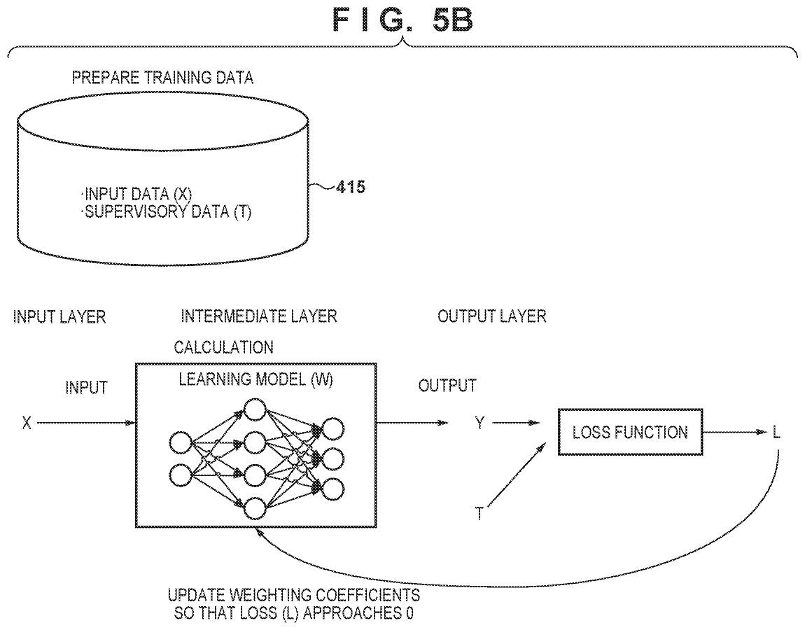

FIGS. 5A and 5B are schematic diagrams that illustrate a structure for inputting/outputting that uses a learning model in the machine learning module 414 of the machine learning server 102 according to the first embodiment, and here, a learning model using a neural network is illustrated as an example.

Training data X, which relates to the generation of a learning model for predicting, by the neural network, an erroneous operation situation as operation information input in X1 to X12 is illustrated. Typical operations and setting information are indicated here for these training data elements, but it is possible to make the training data elements other operations and settings that can be made by the user. Therefore, it goes without saying that the present invention is not limited to operations and setting information as indicated in FIG. 5A. Note that data, in which setting items such as the turning on and turning off of the AI function, the presence/absence of a setting, color/monochrome settings and the like are expressed as categorization variables, is handled in the machine learning as numerical values. Accordingly, configuration may be taken so as to use such data as input of the machine learning processing after converting the data into a numerical value expression by a known method such as one hot encoding as data preprocessing.

As the specific machine learning algorithm, in addition to a neural network, a nearest neighbor algorithm, a Naive Bayes algorithm, decision trees, a support vector machine, and the like may be used. Also, deep learning in which the feature amounts and combine-weighting coefficients for training are self-generated by using a neural network is another example of the specific machine learning algorithm. As appropriate, it is possible to apply one of the applicable above-mentioned algorithms to embodiments.

Also, the learning model may have an error detection module and an update module. The error detection module, in accordance with input data X which is input into an input layer, obtains an error between output data Y that is output from the output layer of the neural network and supervisory data T. Configuration may be taken so as to then, using a loss function, calculate loss L which indicates the error between output data Y from the neural network and the supervised data T.

The update module, based on the loss L obtained by the error detection module, updates combine-weighting coefficients or the like between nodes of the neural network so that the loss becomes smaller. This update module, for example, uses backpropagation to update the combine-weighting coefficient or the like. This backpropagation is a method for adjusting combine-weighting coefficients or the like between respective nodes of the neural network so that the above-mentioned error becomes smaller.

The learning model W prepares a large number of training data in which “input data for which an answer value is known” and the “answer value” are a made to be a set, and adjusts weighting coefficients in the learning model W so that output in the case where input data corresponding to an answer value is input becomes as close as possible to the answer value. By this, the work of obtaining a learning model W that is highly accurate is done. This is referred to as a learning step, and the learning model adjusted through this learning step is referred to as a learned model. The supervisory data (sets of “input data for which the answer value is known” and the “answer value”) prepared here is assumed to be as follows.

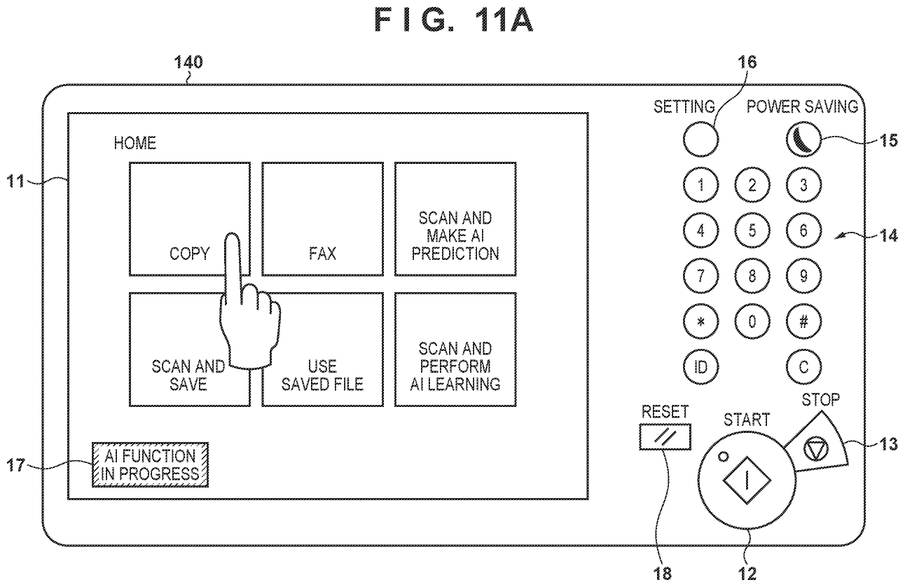

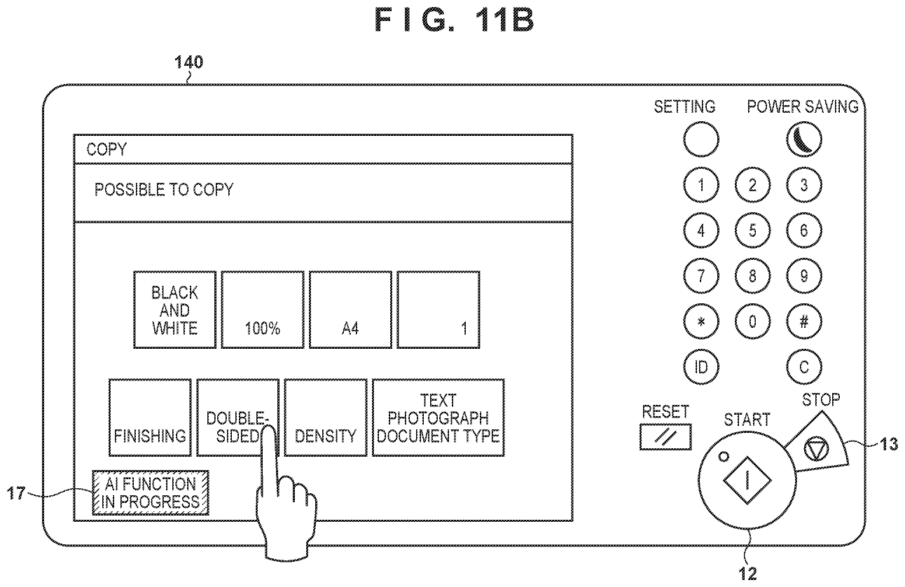

In the first embodiment, an “answer value” for an operation error is made to be an operation and settings immediately prior a stop button 13 (FIG. 11A) of the console unit 140 being pressed, and an operation and settings thereafter are assumed to be for the settings after correction, and training data is input for such sets. An error rate which is made to be an objective variable and erroneous setting and correct setting categorization results are defined as output data and learning is caused to be performed. Here, by associating the operation and settings immediately prior to the stop button being pressed with the answer value for the operation error, it becomes possible to effectively learn the feature amounts of the way in which the operation and setting items are erroneous.

Next, in the first embodiment, a method of learning in relation to a situation in which an operation error occurs in the image forming apparatus 101 and a method of estimating an operation error will be described.

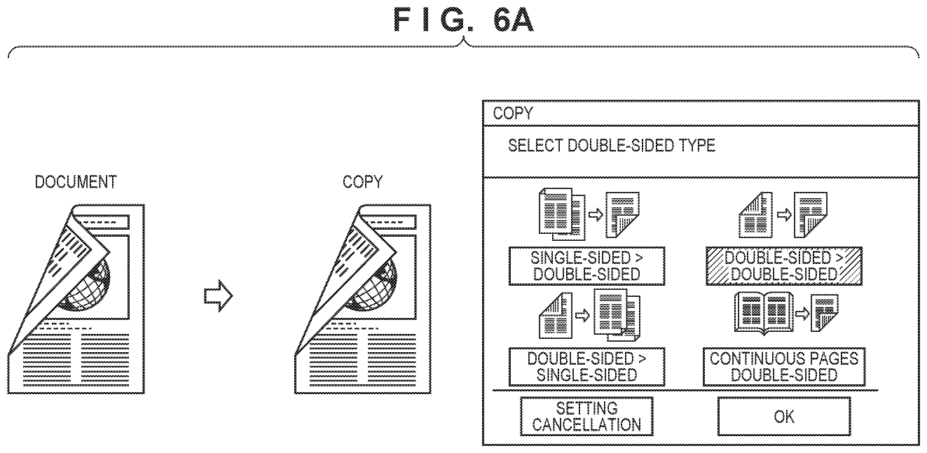

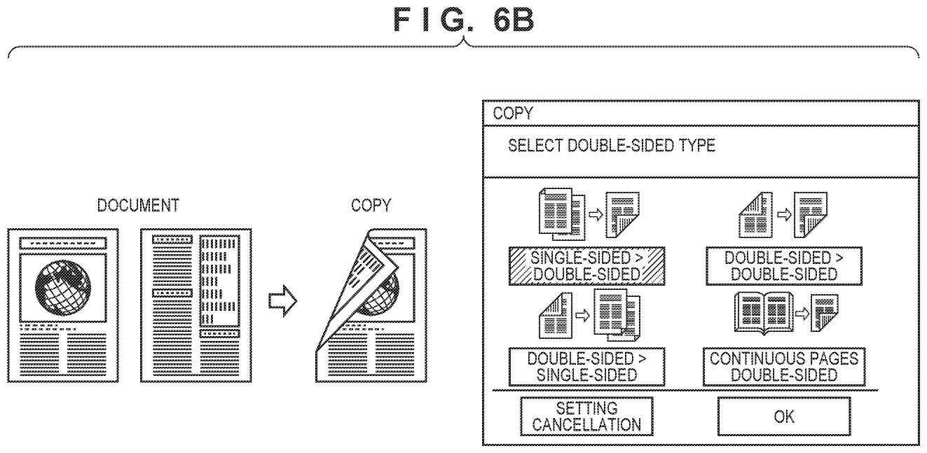

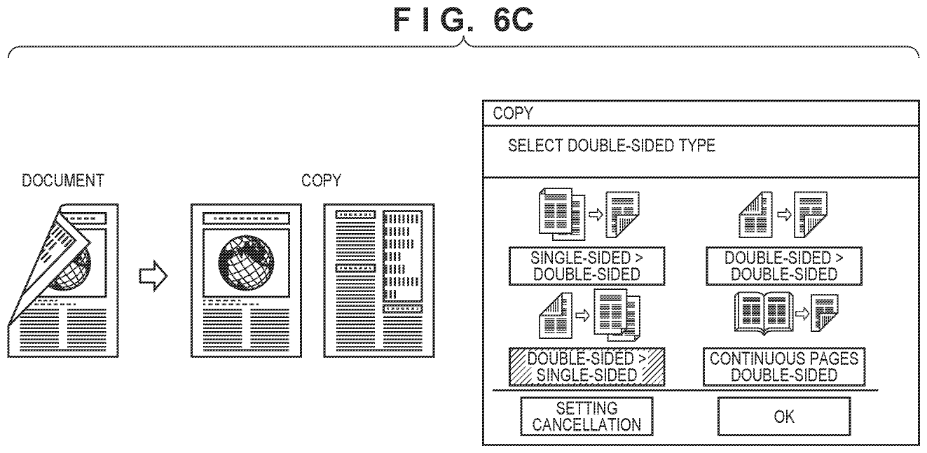

FIGS. 6A through 6C depict views for describing double-sided copy settings as an example of a situation in which an operation error occurs in the image forming apparatus 101 according to the first embodiment.

FIG. 6A illustrates a double-sided/double-sided print setting for printing images of a two-sided document on both sides of a print sheet, FIG. 6B illustrates a single-sided/double-sided print setting for printing images of one-sided documents on both sides of a print sheet, and FIG. 6C illustrates a double-side/single-sided print setting for printing images of a two-sided document on one side of two one-sided print sheets.

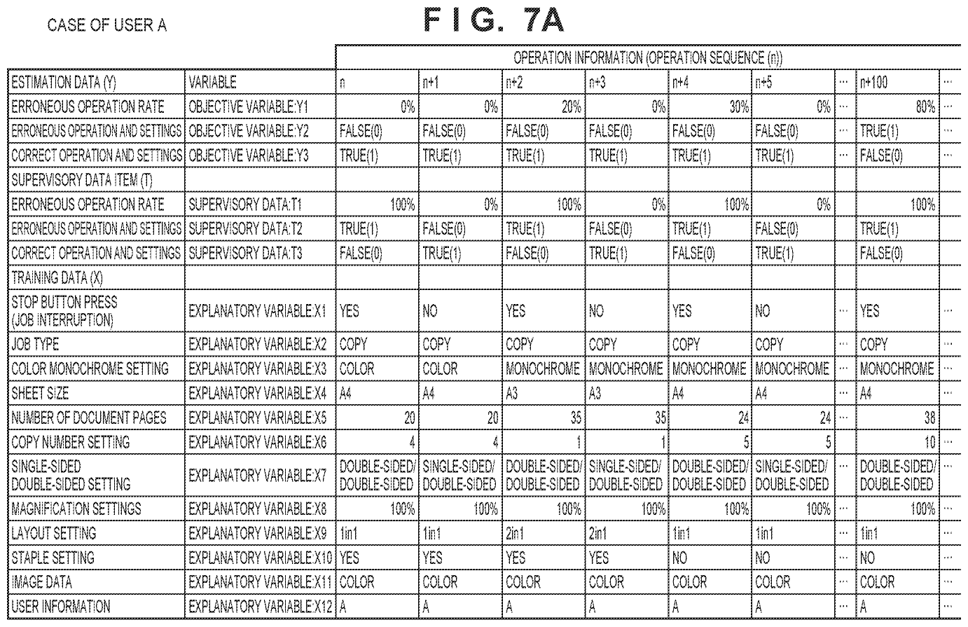

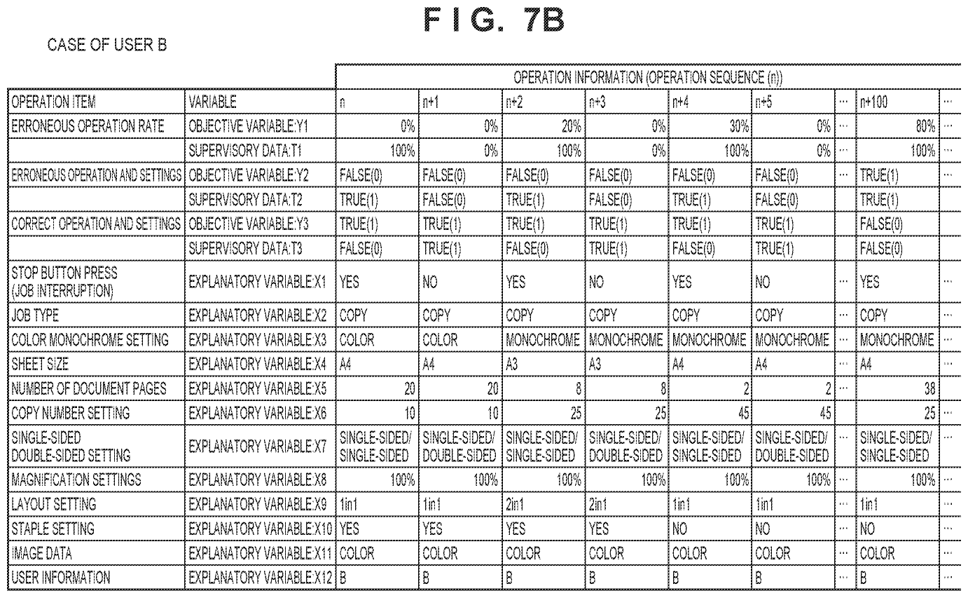

FIGS. 7A and 7B depict views illustrating examples of training data targeted at learning user operation and setting information related to a double-sided print setting.

Here, description will be given of a method for learning so that it is possible to identify an erroneous operation habit of a user A and a user B regarding double-sided print setting related erroneous operation learning and estimation operations.

As illustrated in FIGS. 6A through 6C, the double-sided print setting is a function for accepting a setting as to how to associate a front/back relationship of documents and a front/back relationship of print sheets when performing printing. Here, description will be given assuming a situation in which an erroneous setting is performed due to different particular ways of making a mistake for the user A and the user B.

The ways of making the mistake that are particular to the user are due to different ways that the users normally use the image forming apparatus 101. For example, the user A normally performs a single-sided/double-sided print setting for printing one-sided documents on both sides of a print sheet with the intention to “economize on print sheets when copying one-sided documents”. However, there are cases in which they execute a copy in a state in which they have selected a double-sided/double-sided print setting for copying two-sided documents on both sides of a print sheet due to a rare operation error, and in the middle of the copy, they interrupt the copying having noticed the error.

Meanwhile, the user B normally performs copying with a single-sided/single-sided print setting for printing default one-sided documents on one side of a print sheet with the intention to “copy with a single-sided/double-sided print setting only when there are many copies, and copy the document as it is laid out when there is only one copy”. However, there are cases where they start a copy forgetting to change the setting to the single-sided/double-sided print setting when there are many copies due to a rare operation error, and in the middle of the copy, they interrupt the copying having noticed the error. Accordingly, different ways of making a mistake are assumed due to the difference in intention of the respective users. Examples in which an operation process in which such a mistake occurred is stored are given in FIG. 7A which is an example of operation and setting data for the user A and FIG. 7B which is an example of operation and setting data for the user B.

Also, as a point that is common to each user, in both cases the users themselves notice their mistake and press the stop button to perform a copy job interruption, and correct the settings, and re-execute the job. In the image forming apparatus 101, configuration is such that machine learning is performed with the setting data input in the process of the job interruption and re-execution at that time, at least, as the training data. FIGS. 7A and 7B illustrate examples of the training data.

FIG. 7A illustrates an example of training data in relation to an operation situation of the user A. FIG. 7A illustrates configuration elements of the training data input into the machine learning module 414 illustrated in FIG. 5A on the ordinate, and learning item X (as input data), estimation result Y (as output data), and supervisory data item T corresponding to the estimation result are included therein. Also, operation history corresponding to the operation sequence (n) is stored in the abscissa. The machine learning module 414 learns these three training data element types as described in FIGS. 5A and 5B.

In the image forming apparatus 101, learning operations in sets of: a state in which the stop button is pressed as an operation input indicating directly that an operation error occurred; other operation and setting items; and thereafter corrected operation and setting information are accumulated in order to estimate operation errors. Examples of such a learning process are indicated by operation sequence (n) to operation sequence (n+100).

In operation sequence (n), the user A, in relation to a setting recited for the learning items shown graphically, interrupts the job by pressing the stop button. At that point in time, the learned model is in an initial state and an estimation result of the erroneous operation rate for the erroneous operation estimation model is 0%.

At the operation sequence (n), the stop button is pressed, and therefore the erroneous operation rate T1 of the supervisory data is 100% and the loss is calculated by obtaining an error with respect to the estimation result Y1 of the erroneous operation rate. As described in FIG. 5B in this way, the combine-weighting coefficients between nodes in the neural network are updated so that this loss becomes small. This sequence of operations is performed every time the operation sequence (n) is updated.

Next, the operation sequence (n+1) is changed to the setting that corrected the erroneous setting for the setting of the operation sequence (n). The stop button is not pressed during execution of the job. In relation to this setting item, learning is caused to be performed similarly to the operation sequence (n) where the erroneous operation rate T1 of the supervisory data is 0%.

In the case of the next operation sequence (n+2), the erroneous operation rate Y1 is output as 20%. Combine-weighting coefficients and the like between nodes of the neural network are updated by learning up to operation sequence (n+2). The result of this is that the learned model indicates the erroneous operation rate estimated for explanatory variables upon the operation and settings (X2 to X12) of the operation sequence (n+2).

Accordingly, the result of learning of operation sequence (n+3) to operation sequence (n+100), is that the result of estimating the erroneous operation rate at the point in time of operation sequence (n+100) is 80%. Accordingly, by repeating learning from the initial learned model, the estimation rate in the case of setting indicating the features of the erroneous operation ends up converging gradually at a high level.

Also, in the example shown graphically, it is indicated that the learned model can output, as the objective variable, the categorization results “erroneous operation and setting Y2” and “correct operation and setting Y3” as the estimation results. This is because the user can change the manner of the notification of the results of the erroneous operation estimation via the console unit 140, in accordance with their objective. For example, in the case where only results that indicate correct are needed, configuration may also be taken such that a determination as to whether to notify the user is performed considering a threshold for that correctness. Accordingly, it is possible for the balance between an inhibitory effect of the erroneous operation and the frequency of notification to be adjusted. Accordingly, it is thought that usability, as a notification function of an erroneous operation estimation premised upon machine learning in the presence of a certain amount of estimation error, will improve. Note that the learning results shown graphically and the progress thereof are examples illustrating the erroneous operation estimation model training method and training data features, and it goes without saying that the present invention is not limited to the examples shown graphically.

FIGS. 11A and 11B depict views illustrating examples of screens displayed on the console unit 140 of the image forming apparatus 101 according to the first embodiment.

The operation panel 11 of the console unit 140 combines a liquid crystal display and a touch panel, for example, and in addition to displaying an operation screen, when a displayed key is pressed by the user, information thereof is sent to the controller 2200. The start button 12 is used when starting an operation for reading an original image and printing it and for making an instruction to start other functions. Green and red LEDs are embedded in the start button 12, and the lighting of the green one indicates that start is possible and the lighting of the red on indicates that start is impossible. The stop button 13 functions to stop an operation that is currently in progress. A group of hardware keys 14 includes a numeric keypad, a clear key, a reset key 18, and a setting key 16. Also, the power saving key 15 is used when causing, from the console unit 140, the image forming apparatus to transition to a sleep mode or to return from the sleep mode. The image forming apparatus 101 transitions to the sleep mode when the power saving key 15 is pressed by the user in the normal mode, and transitions to the normal mode when the power saving key 15 is pressed by the user in the sleep mode. The setting key 16 is used when performing settings such as the AI function setting. Also, the console unit 140 transmits to the console unit interface 2206 the user name and number of print sheets that the user input using the operation panel 11 and information needed for generation of job information such as output attribute information.

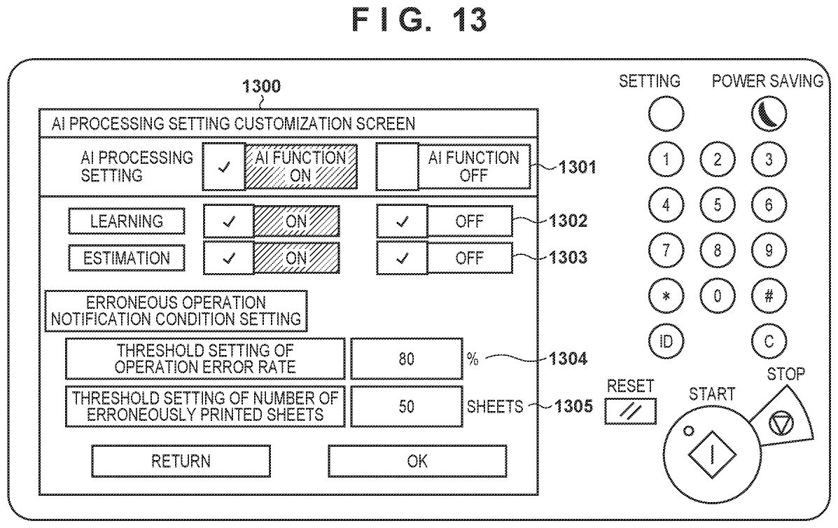

The display of the operation panel 11 in FIG. 11A illustrates an example of the home screen. The user is enabled to select a function that the image forming apparatus 101 provides via this home screen. Also, here, an AI function icon 17 which displays the status of the AI function is caused to be displayed, and the user can thereby recognize the operational status of the AI function. The user, by touching this AI function icon 17, can cause a transition to an AI function setting screen illustrated in FIG. 13. Also, FIG. 11B illustrates an example of an initial setting screen for copying. The user, by touching this AI function icon 17, can cause a transition to an AI function setting customization screen illustrated in FIG. 13.

FIG. 13 depicts a view illustrating an example of an AI processing setting customization screen displayed on the console unit 140 of the image forming apparatus 101 according to the first embodiment.

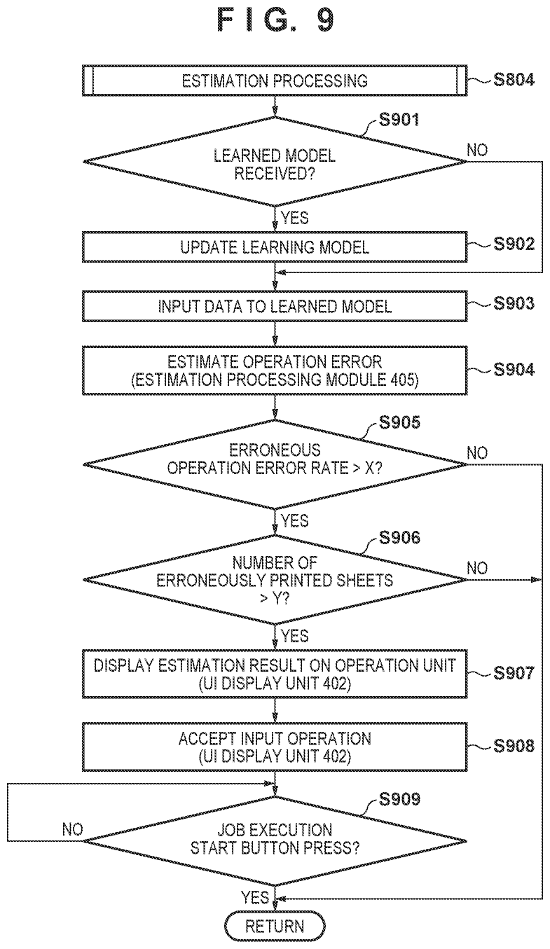

This AI processing setting screen 1300 is such that detailed settings for the AI processing are performed. For example, a selection 1301 for setting whether the AI function is on/off can be accepted by a check in a checkbox. Also, a learning field 1302 and an estimation field 1303 are provided as selection items so that it is possible to independently turn on and turn off learning and estimation respectively. In this selection of processing details for the AI processing, it is possible to accept a selection as processing that prohibits one or both of learning and estimation. With a threshold setting value 1304 of an operation error rate, it is possible to set a threshold (predetermined value) for the operation error rate so that it is possible to adjust to an expected operational feeling, in consideration of the frequency of operation error notifications and the accuracy of notification content by the user. With a threshold setting value 1305 of a number of erroneously printed sheets, it is possible for the user to set so that when the number of erroneously printed sheets becomes a threshold (a predetermined value), a notification of an operation error is made in consideration of the frequency of notifications of an operation error and the accuracy of notification contents. Such setting values are referenced in estimation processing of FIG. 9 which will be described later. This number of erroneously printed sheets is one example expressing the number of events that occurred due to an error in an operation of a user.

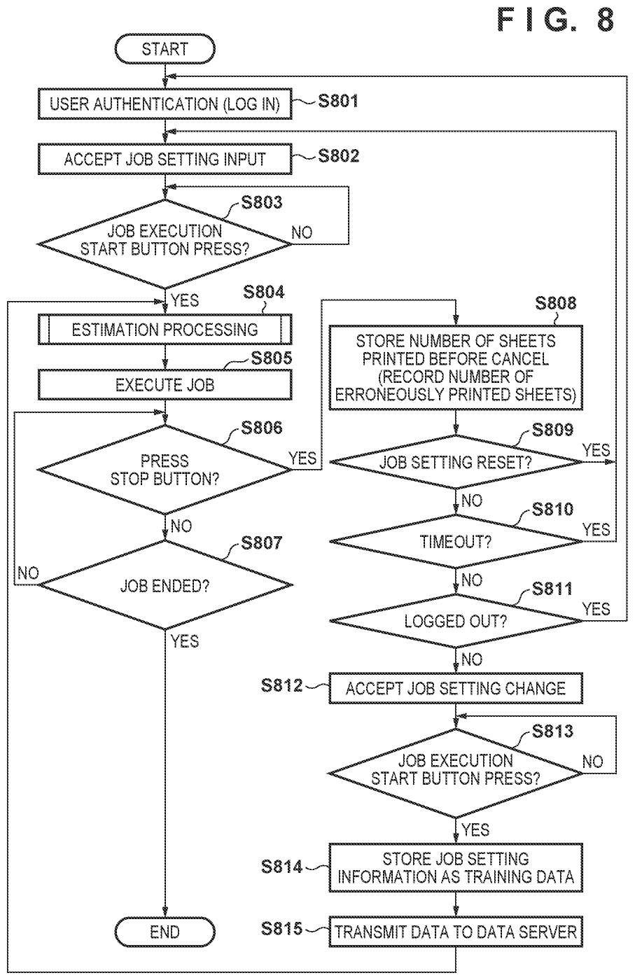

FIG. 8 is a flowchart for describing processing by the image forming apparatus 101 according to the first embodiment. This processing illustrates processing from when an operation input is accepted to when the erroneous operation estimation processing is performed and a notification thereof is performed. Note that the processing described in this flowchart is achieved by a program that the CPU 2201 deployed in the RAM 2202 being executed.

First, in step S801, the CPU 2201 performs user authentication by accepting input of an authentication code from the console unit 140 or via an IC card reader (not shown) or the like. In this way, when the user authentication succeeds, the processing advances to step S802, and the CPU 2201 accepts input of a job setting from the authenticated user. Next, the processing advances to step S803, and the CPU 2201 waits for the start button 12 for instructing the start of execution of a job to be pressed by the user, and when the start button 12 is pressed, the processing advances to step S804, and the CPU 2201 performs processing for estimating. The estimation processing of the step S804 is described later with reference to the flowchart of FIG. 9.

When the estimation processing has been executed in step S804, the processing advances to the job of step S805, and the CPU 2201 executes the job based on the set conditions. Next, the processing advances to step S806, and the CPU 2201 determines whether or not the stop button 13 of the console unit 140 is pressed and the execution of the job is cancelled (interrupted). If the stop button 13 has not been pressed here, the processing advances to step S807, and the CPU 2201 determines whether or not the job ended, and when it determines that the job has ended, the CPU 2201 ends this processing, and otherwise, the processing advances to step S806.

In step S806, if the stop button 13 is pressed and the job is cancelled, the processing advances to step S808, the CPU 2201 stores the number of sheets printed until the job is cancelled in association with information of the logged in user in the data storage module 401. The storage details in step S808 are used in estimation processing that will be described later. Next, the processing advances to step S809, and the CPU 2201 determines whether or not the job settings are reset. When it is determined that job settings are reset here, the processing returns to step S801, and when it is determined that the job settings are not reset, the processing advances to step S810.

In step S810, the CPU 2201 determines whether or not a timeout has occurred by the timer 2209. This determines whether or not there is a timeout based on a time setting of the timer 2209 for up until initialization of the operation and setting values is performed. The user, via a UI operation screen (not shown), can set any timer value. Here, when it is determined that a time out has not occurred, the processing advances to step S811, and the CPU 2201 determines whether or not the user logged out. Here, in the case where the user is determined to have logged out, the processing returns to the user authentication acceptance of step S801.

Meanwhile, when it is determined that the user is not logged out, the processing advances to step S812, and the CPU 2201 accepts a job setting change. Then, the processing advances to step S813, and the CPU 2201 determines whether or not the start button 12 for instructing to start the execution of the job is pressed. When it is determined that the start button 12 is pressed here, the processing advances to step S814, and the CPU 2201 stores in the data storage module 401 job setting information as the training data in the erroneous operation estimation model. Then, the processing advances to step S815, and the CPU 2201 transmits to the data server 105 the stored training data, and returns to the estimation processing of step S804.

FIG. 9 is a flowchart for describing estimation processing of step S804 of FIG. 8.

Firstly, in step S901, the CPU 2201 determines whether the learned model is received from the machine learning server 102. When it is determined that the model has been received here, the processing advances to step S902, and in addition to the CPU 2201 storing the learning model, it updates the learned model to be used for estimation processing, and the processing advances to step S903. Meanwhile, in step S901, when the learned model has not been received, the processing advances to step S903. In step S903, the CPU 2201 inputs data to the learned model. Next, the processing advances to step S904, and the CPU 2201 obtains the result of estimating an operation error that the learned model outputs in response to this input. Next, the processing advances to step S905, and the CPU 2201 determines whether the obtained estimation result is larger than the predetermined threshold X.

This threshold X is compared with the threshold setting value 1304 of the operation error rate that is set via the AI processing setting customization screen illustrated in the previously described FIG. 13. This can be set to the threshold value of the operation error rate such that it is possible for the user to adjust to an expected operational feeling in consideration of the frequency of notification of an operation error and notification content accuracy.

In step S905, if the operation error rate is smaller than the threshold X that is set, the processing is ended. Meanwhile, if this estimation result is the threshold X or more, the processing advances to step S906, and the CPU 2201 compares the number of print sheets that were printed thus far and the threshold Y. Note that this number of print sheets is the number of print sheets obtained in step S808 as previously described.

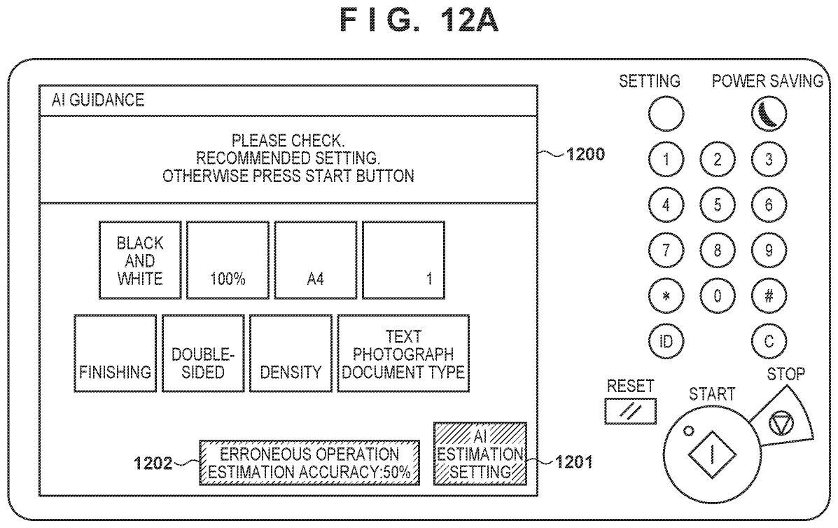

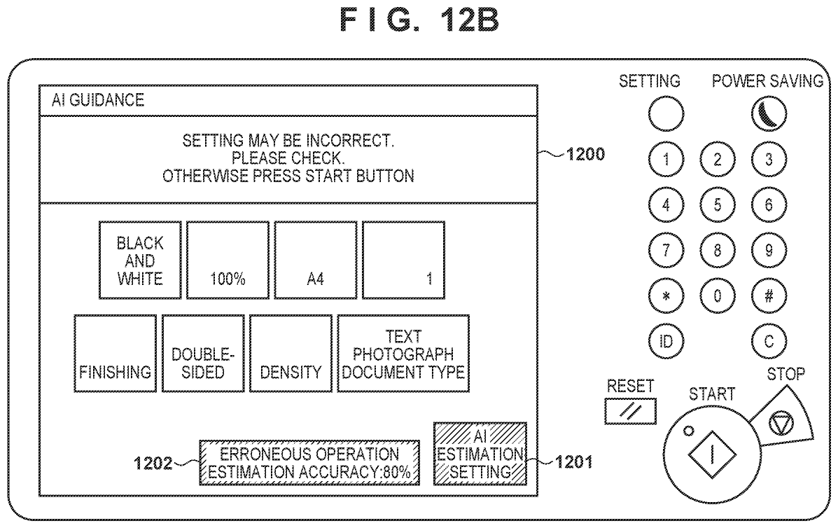

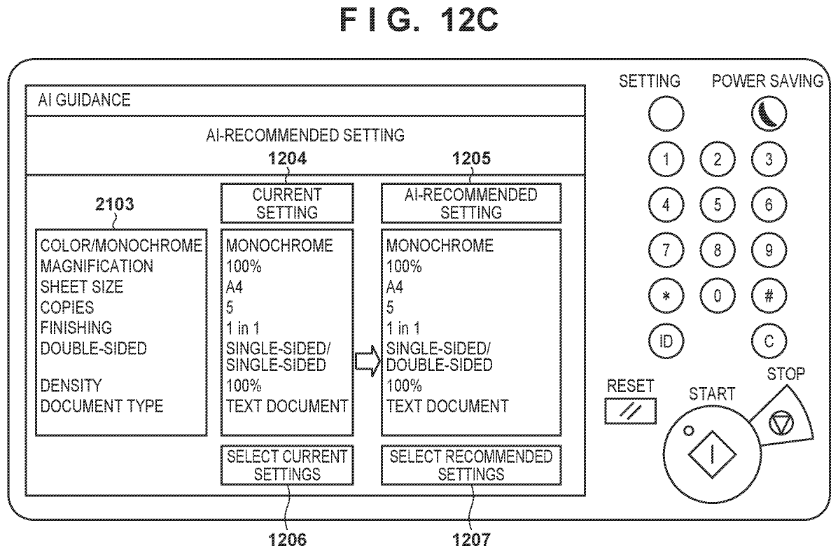

The number of print sheets output at the point in time when a job execution was interrupted part way through in the past is compared with the threshold setting value 1305 of the number of erroneously printed sheets input via the AI processing setting customization screen illustrated in the previously described FIG. 13. If the number of print sheets is more than the threshold Y, the processing advances to step S907, and if the number of print sheets is the threshold Y or less, this estimation processing is ended. In step S907, the CPU 2201 displays, on the console unit 140, the results of this estimation on a notification screen such as is illustrated in FIGS. 12A to 12C. Then, the processing advances to step S908, and the CPU 2201 accepts an operation by the user via the notification screen displayed on the console unit 140, and advances the processing to step S909. Then, the CPU 2201 determines whether the start button 12 for instructing to start execution of a job is pressed, and if the start button 12 is pressed, ends this estimation processing.

Here, the objective of comparing the number of erroneously printed sheets with the threshold and setting a condition for displaying the screen by which to notify the user of the erroneous operation estimation results is so that it is possible to adjust the manner of notification in the form in which an influence degree of the erroneous operation has been reflected. The number of sheets that has been erroneously printed is a parameter that is not correlated with the erroneous operation estimation directly and is not an element in the learning of the erroneous operation estimation. However, the determination as to the number of sheets that has been erroneously printed is performed because it is considered more advantageous to be able to selectively adjust separate adjustment parameters in consideration of the importance of the erroneous operation notification in practice taking into account the frequency of notification.

Accordingly, the threshold setting for the operation error rate and the threshold setting for the number of erroneously printed sheets are illustrated as additional elements for a feature portion in the embodiment.

FIGS. 12A to 12C depict views for respectively describing screens for notifying the user of the results of erroneous operation estimation in the image forming apparatus 101 according to the first embodiment. Here, FIG. 12A and FIG. 12B illustrate examples of the notification screen.

In FIGS. 12A and 12B, configuration elements according to the notification include a message display area 1200, an AI estimation setting icon 1201, and an erroneous operation estimation accuracy display area 1202. In the examples shown graphically, a state in which the notification message being displayed on the message display area 1200 changes in conjunction with the estimation accuracy value of the erroneous operation is illustrated. In other words, in a case where estimation accuracy is high at “80%” as illustrated in FIG. 12B, a mistake in operation and settings is expressed assertively by the notification message details. In contrast to this, in FIG. 12A, since the estimation accuracy is relatively low at “50%”, the expression softens to notify that “there are recommended settings”. With such a display style, since there are the qualities that there are estimation errors in the learning results and the learning proficiency changes, the notification results enable quantitative and qualitative information to be ascertained as materials by which the user can make a final determination. Note that another method of presenting the notification results may be employed if it enables the user to ascertain the quantitative or qualitative information.

FIG. 12C illustrates an example of a screen displayed upon a press of the AI estimation setting icon 1201. FIG. 12C illustrates an example of a recommended AI setting screen in which the details of an erroneous setting estimated by the erroneous operation estimation model are reflected. The recommended AI setting screen has a setting item display area 1203, a current setting display area 1204, and an AI recommended setting display area 1205. Also, an icon 1206 for selecting the current settings and an icon 1207 for selecting the recommended settings are arranged. By this, the user can confirm the notification content and instruct whether or not to change the setting details and can ascertain whether a current problem will be solved if the change is made. The example of FIG. 12C illustrates an example in which “single-sided/double-sided” is recommended as the double-sided setting in relation to the current settings.

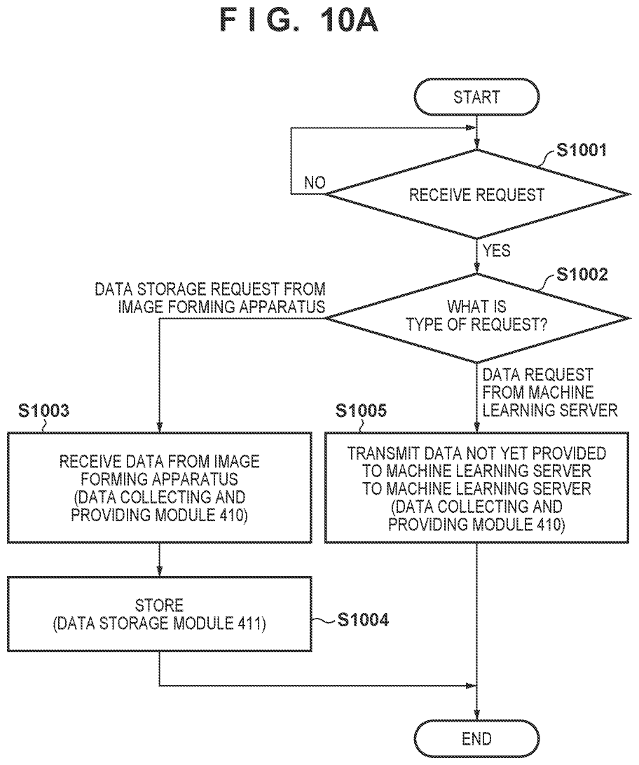

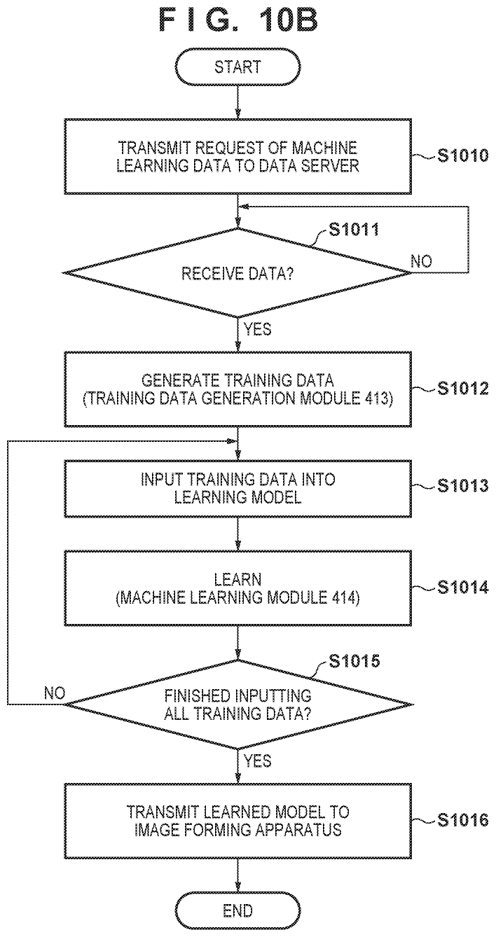

FIG. 10A is a flowchart for describing an operation of the data server 105 according to the first embodiment. Note that the processing illustrated in this flowchart is achieved by a program that the CPU (not shown) of the data server 105 deployed in the RAM (not shown) of the same data server 105 being executed.

Firstly, in step S1001, the CPU of the data server 105 stands by to receive a data communication request, and when such a communication request is received, advances the processing to step S1002. In step S1002, the CPU of the data server 105 determines the type of the communication request, and in a case where the communication request is a transmission request indicating data storage from the image forming apparatus 101, the processing advances to step S1003, and the data is received from the image forming apparatus 101, and the received data is stored by the data storage module 401 in step S1004, and this processing is ended.

Meanwhile, when, in step S1002, it is determined that the communication request is a request from the machine learning server 102, the processing advances to step S1005, and among the stored data, transmits to the machine learning server 102 data that has not vet been provided to the machine learning server 102, and then ends this processing.

FIG. 10B is a flowchart for describing an operation of the machine learning server 102 according to the first embodiment. Note that the processing illustrated in this flowchart is achieved by a program that the CPU 3301 of the machine learning server 102 deployed in the RAM 3302 being executed.

Firstly, in step S1010, the CPU 3301 transmits a transmission request of machine learning data to the data server 105. Next, the processing advances to step S1011, and the CPU 3301, in response to the request, determines whether or not data transmitted from the data server 105 is received, and when the data has been received, the processing advances to step S1012, and the CPU 3301 generates training data for the erroneous operation estimation based on the received data. Next, the processing advances to step S1013, and the CPU 3301 inputs the generated training data into the learning model. By this, the machine learning module 414 performs learning based on the training data for the input estimation in step S1014. Then, the processing advances to step S1015, and the CPU 3301 repeatedly performs learning until all processing of the received training data has ended, and when the learning of all the training data has ended. The processing proceeds to step S1016 and the CPU 3301 transmits the learned model to the image forming apparatus 101, and ends the processing.

Accordingly, the machine learning server 102 generates learned data by performing learning based on data for machine learning provided by the data server 105. Thus far, features of operations of the image forming apparatus 101, the data server 105, and the machine learning server 102 according to the first embodiment have been described.

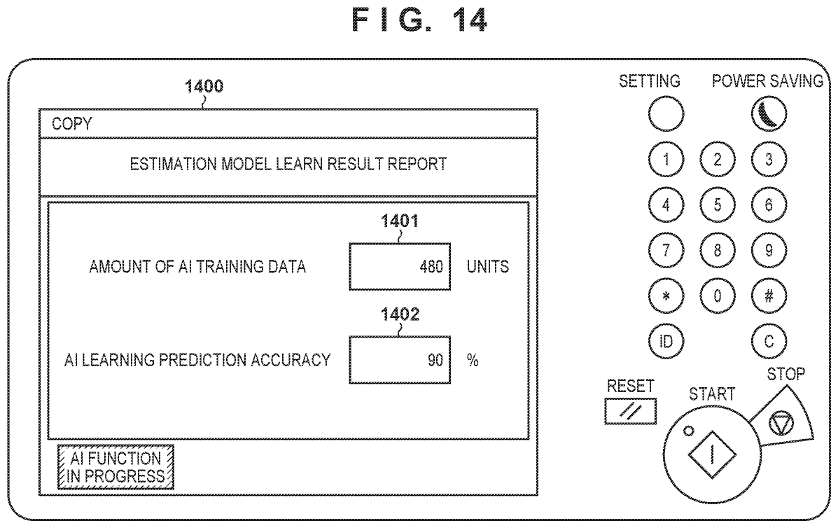

FIG. 14 depicts a view illustrating an example of a screen 1400 for displaying a learning result that is displayed on the console unit 140 of the image forming apparatus 101 according to the first embodiment.

This learning result display screen 1400 displays information by which a user can ascertain an amount of training data in the AI processing and a learning accuracy. As shown graphically, “480” is displayed in the AI learning data amount field 1401 and a percentage numerical value (90% in FIG. 14) is displayed in the AI learning prediction accuracy field 1402 in the AI learning prediction accuracy field 1402 as an evaluation index of a result of learning by a learning model illustrated in FIGS. 5A and 5B. By this, the user can ascertain an amount of the training data and the prediction accuracy. Also, configuration may be taken, in place of these numerical values, to display in the form of a graph, for example.

By virtue of the first embodiment as described above, with at least the state in which stop button is pressed and the operation information before/after that as training data, the operation information is learned, and a learned model for performing processing for estimating an operation error situation is generated. Then, by using the generated learned model, it is possible to estimate a user operation error. Then, in the case where it is estimated that there is a user operation error, it is possible to make a notification to the user.

Furthermore, the notification frequency can be adjusted by a threshold setting such as, for example, the error rate or the number of sheets that have been erroneously printed. By this, the user can adjust to an expected operational feeling taking into consideration the operation error notification frequency and the accuracy of the notification content.

### Second Embodiment

Below, a second embodiment for implementing the present invention will be described using the figures. In the second embodiment, the image forming apparatus 101 has a function of the data server 105 and the machine learning server 102 according to the first embodiment, and thereby the image forming apparatus 101 on its own can collect the training data, and execute training processing based on the training data. Note that the hardware configuration of the image forming apparatus 101 according to the second embodiment is similar to the previously described first embodiment, and therefore the description thereof is omitted.

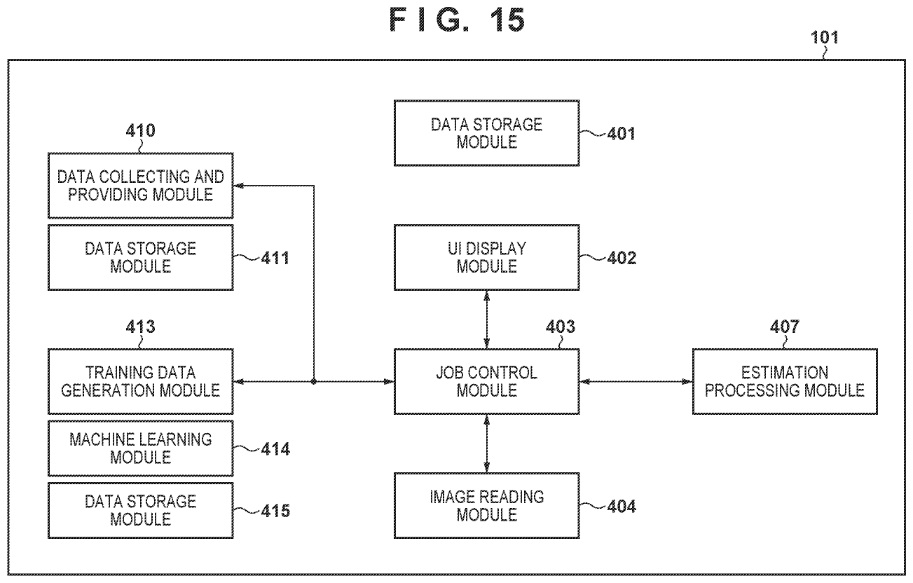

FIG. 15 depicts a view for describing a software configuration of the image forming apparatus 101 according to the second embodiment of the present invention. In FIG. 15, functions that are common to the previously described FIG. 4 are given the same reference numerals and description thereof is omitted.

The point of difference from the previously described first embodiment is that the image forming apparatus 101 according to the second embodiment has the functions of the data server 105 and the machine learning server 102 according to the first embodiment. In other words, by the CPU 2201 and the GPU 2291, functional blocks illustrated in this FIG. 15 are executed.

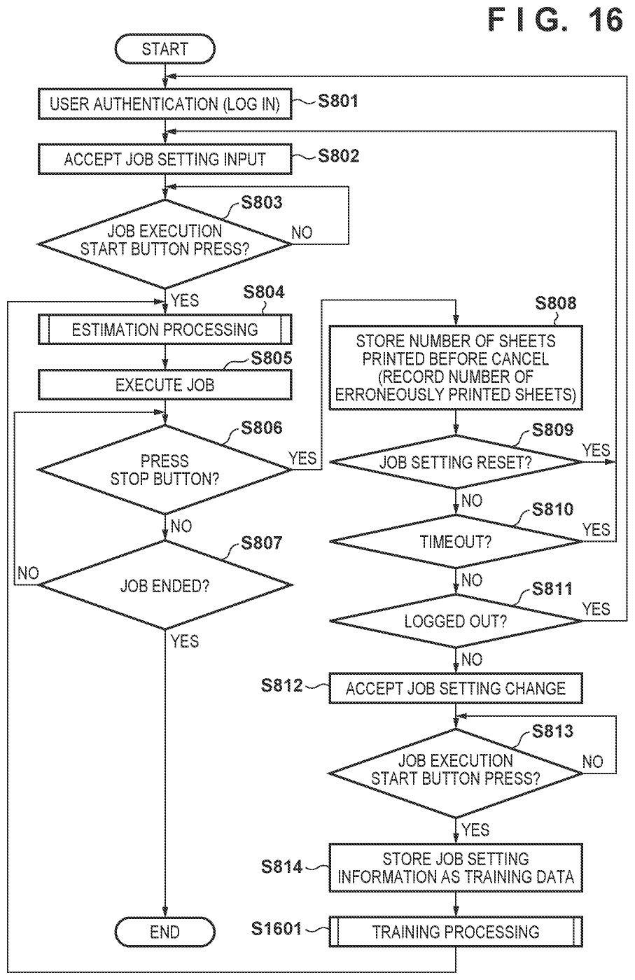

FIG. 16 is a flowchart for describing an operation of the image forming apparatus 101 according to the second embodiment of the present invention. In this flowchart, processing that is common to the flowchart of FIG. 8 of the first embodiment is indicated by the same reference numerals, and description thereof is omitted.

In the flowchart of FIG. 8, in step S815, stored training data is transmitted to the data server 105, whereas in the flowchart of FIG. 16, in step S1601, training processing is performed on the image forming apparatus 101.

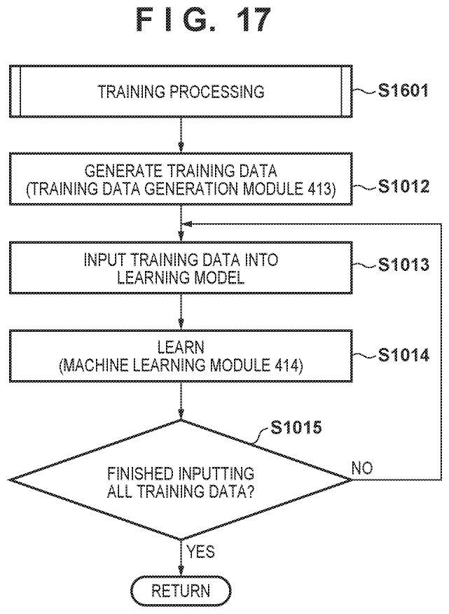

FIG. 17 is a flowchart for describing processing of step S1601 of FIG. 16, and illustrates processing that is common to step S1012 to step S1015 of the flowchart of FIG. 10B of the first embodiment. A description of this processing is omitted since it is the same as in FIG. 10B.

Accordingly, by virtue of the second embodiment, it is possible to achieve a similar effect to the first embodiment with the image forming apparatus 101 on its own.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-030852, filed Feb. 26, 2020, which is hereby incorporated by reference herein in its entirety.

What is claimed is:

1. An information processing apparatus, comprising:
at least one processor and at least one memory configured to function as:
a learning unit that generates a learned model for estimating an operation error situation, using operation information of the information processing apparatus as training data.
an estimation unit that estimates an error of an operation by a user by using the learned model generated by the learning unit; and
a notification unit that makes a notification to the user of an estimation result by the estimation unit.

2. The information processing apparatus according to claim 1, wherein the estimation unit estimates the error of the operation by the user by using at least a categorization of whether an operation by the user is correct or erroneous and a prediction of an error rate of an operation by the user.

3. The information processing apparatus according to claim 1, wherein the at least one processor and the at least one memory configured to further function as:
a setting unit that sets a condition for the notification unit to make the notification to the user of the estimation result.

4. The information processing apparatus according to claim 3, wherein the condition includes a case where an error rate of an operation by the user is larger than a predetermined value.

5. The information processing apparatus according to claim 3, wherein the condition includes a case where a number of events that occurred due to an error of an operation by the user is larger than a predetermined value.

6. The information processing apparatus according to claim 1, wherein the notification unit makes a notification including an accuracy of the estimation result.

7. The information processing apparatus according to claim 1, wherein the notification unit further provides a recommended setting for solving the error of the operation of the user based on the learned model.

8. The information processing apparatus according to claim 1, wherein the learning unit, as elements of the training data, collects at least a state in which a stop button is pressed and operation and setting information before/after that state, and generates the learned model.

9. The information processing apparatus according to claim 1, wherein the at least one processor and the at least one memory are configured to further function as:
a display unit that displays an amount of the training data and a prediction accuracy of an error rate of an operation by the user.

10. An information processing system that has at least an image forming apparatus, a learning server, and a data server,
the data server comprising:
at least one first processor and at least one first memory configured to cause the data server to:
collect data for learning and provide the data for learning to the learning server,
the learning server comprising:
at least one second processor and at least one second memory configured to cause the learning server to:
generate a learned model based on the data for learning provided from the data server, and
the image forming apparatus comprising:
at least one third processor and at least one third memory configured to function as:
an estimation unit that obtains the learned model from the learning server, and estimates an error of an operation by a user by using the learned model; and
a notification unit that makes a notification to the user of an estimation result by the estimation unit.

11. A method of controlling an information processing apparatus, the method comprising:
generating a learned model for estimating an operation error situation, using operation information of the information processing apparatus as training data;
estimating an error of an operation by a user by using the generated learned model; and
making a notification to the user of a result of the estimation.
